(19) United States
(12) Patent Application Publication
(10) Pub. No.: US 2026/0061992 A1
(43) Pub. Date: Mar. 5, 2026

(54) AUTOMATED VALET PARKING SYSTEM

(71) Applicant: TOYOTA JIDOSHA KABUSHIKI KAISHA, Toyota-shi (JP)

(72) Inventor: Amane YAJIMA, Ashigarakami-gun (JP)

(73) Assignee: TOYOTA JIDOSHA KABUSHIKI KAISHA, Toyota-shi (JP)

(21) Appl. No.: 19/272,644

(22) Filed: Jul. 17, 2025

(30) Foreign Application Priority Data
Aug. 29, 2024 (JP) 2024-147387

(51) Int. Cl. B60W 30/06

(52) U.S. Cl. CPC B60W 30/06; B60W 2520/04; B60W 2530/18; B60W 2556/45

(57) ABSTRACT

A control device is configured to perform vehicle control for automated valet parking based on a traveling path intermittently received from a management device. The vehicle control includes processing of determining restart of the vehicle based on the latest traveling path when the control device receives a latest traveling path from the management device in a case where a traveling state of the vehicle corresponds to a state acquired immediately after the vehicle stops. In the processing of determining the restart, the restart is prohibited in a case where a distance from a stop position of the vehicle to a target position included in a path end point of the latest traveling path is determined to be equal to or less than a specified distance.

### CROSS-REFERENCE TO RELATED APPLICATION

This application claims priority to Japanese Patent Application No. 2024-147387 filed on August 29, 2024. The disclosure of the above-identified application, including the specification, drawings, and claims, is incorporated by reference herein in its entirety.

### BACKGROUND

### 1. Technical Field

The present disclosure relates to an automated valet parking (AVP) system of a vehicle within a predetermined area such as a parking area.

### 2. Description of Related Art

Japanese Patent No. 6756828 (JP 6756828 B) discloses a method for guiding a vehicle within a parking area. In this guiding method, an external device specifies a traveling path for remotely controlling a vehicle to be guided and transmits the traveling path to the vehicle to be guided. Further, in the guiding method, the external device divides the specified traveling path into subintervals and transmits them to the vehicle to be guided.

### SUMMARY

While not specifically mentioned in JP 6756828 B, as information included in the traveling path, identification information is conceivable. The identification information is information for distinguishing the traveling path divided into subintervals from other traveling paths.

In a case where the external device transmits the traveling path divided into subintervals, the vehicle to be guided sequentially receives the traveling path. In this case, the traveling path that is sequentially received can be identified by the identification information. Even in a case where a reception frequency of the traveling path divided into subintervals is high and there is little difference among information included in these subintervals, these traveling paths can be identified.

However, in a case where a new traveling path for making a minor adjustment of a stop position of the vehicle is received immediately after the vehicle to be guided stops, there is the following concern. In other words, in a case of minor adjustment of the stop position, there is little difference between information included in subintervals of the traveling path received immediately before the new traveling path is received and information included in subintervals of the traveling path received this time. However, the vehicle that has received the new traveling path performs arithmetic processing based on the information included in this traveling path, and thus, hunting of an internal state of the vehicle occurs or actuator control that is originally unnecessary is performed.

The present disclosure provides a technology capable of avoiding occurrence of a failure when a vehicle newly receives a traveling path immediately after the vehicle stops in a case where automated valet parking of the vehicle based on a traveling path sequentially received from an external device is performed.

A system that is configured to perform automated valet parking of a vehicle within a predetermined area according to a first aspect of the present disclosure includes a management device configured to manage the automated valet parking, and a control device mounted on the vehicle and configured to perform vehicle control for the automated valet parking based on a traveling path intermittently received from the management device. The traveling path includes a plurality of path points. Each of the plurality of path points includes information on a target position of the vehicle. The vehicle control includes processing of determining restart of the vehicle based on the latest traveling path when the control device receives a latest traveling path from the management device in a case where a traveling state of the vehicle corresponds to a state acquired immediately after the vehicle stops. The processing of determining the restart includes determining whether or not a distance from a stop position of the vehicle to the target position included in a path end point of the latest traveling path is equal to or less than a specified distance, and prohibiting the restart in a case where the distance is determined to be equal to or less than the specified distance and allowing the restart in a case where the distance is determined not to be equal to or less than the specified distance.

A system that is configured to perform automated valet parking of a vehicle within a predetermined area according to a second aspect of the present disclosure includes a management device configured to manage the automated valet parking, and a control device mounted on the vehicle and configured to perform vehicle control for the automated valet parking based on a traveling path intermittently received from the management device. The traveling path includes a plurality of path points. Each of the plurality of path points includes information on a target position of the vehicle. The vehicle control includes processing of determining restart of the vehicle based on the latest traveling path when the control device receives a latest traveling path from the management device in a case where a traveling state of the vehicle corresponds to a state acquired immediately after the vehicle stop. The processing of determining the restart includes determining whether or not respective target positions of a plurality of path points included in the latest traveling path coincide with respective target positions of a plurality of path points included in a past traveling path received from the management device before the latest traveling path is received, and prohibiting the restart in a case where the respective target positions of the latest traveling path are determined to coincide with the respective target positions of the past traveling path and allowing the restart in a case where the respective target positions of the latest traveling path are determined not to coincide with the respective target positions of the past traveling path.

In the system according to the first aspect of the present disclosure, in a case where the control device prohibits the restart, the control device may be configured to further perform processing of transmitting a transmission stop request of the traveling path to the management device.

In the system according to the first aspect of the present disclosure, the management device may be configured to perform processing of determining transmission of a traveling path to be transmitted to the vehicle, and the processing of determining transmission of the traveling path to be transmitted may include determining whether or not a distance from the stop position of the vehicle to the target position included in a path end point of the traveling path to be transmitted is equal to or less than the specified distance, and prohibiting the transmission of the traveling path to be transmitted in a case where the distance is determined to be equal to or less than the specified distance and allowing the transmission of the traveling path to be transmitted in a case where the distance is determined not to be equal to or less than the specified distance.

In the system according to the first aspect of the present disclosure, the management device may be configured to perform processing of determining transmission of a traveling path to be transmitted to the vehicle, and the processing of determining transmission of the traveling path to be transmitted may include determining whether or not respective target positions of a plurality of path points included in the traveling path to be transmitted coincide with respective target positions of a traveling path that has been transmitted to the vehicle before the traveling path to be transmitted is transmitted, and prohibiting the transmission of the traveling path to be transmitted in a case where the respective target positions of the traveling path to be transmitted are determined to coincide with the respective target positions of the traveling path that has been transmitted and allowing the transmission of the traveling path to be transmitted in a case where the respective target positions of the traveling path to be transmitted are determined not to coincide with the respective target positions of the traveling path that has been transmitted.

In the system according to the first aspect of the present disclosure, the management device may be configured to perform processing of setting a transmission period of a traveling path to be transmitted to the vehicle, and the processing of setting the transmission period may include determining whether or not a distance from the stop position of the vehicle to the target position included in a path end point of the traveling path to be transmitted is equal to or less than the specified distance, and changing the transmission period to a period longer than a basic period in a case where the distance is determined to be equal to or less than the specified distance and maintaining the transmission period at the basic period in a case where the distance is determined not to be equal to or less than the specified distance.

In the system according to the first aspect of the present disclosure, the management device may be configured to perform processing of setting a transmission period of a traveling path to be transmitted to the vehicle, and the processing of setting the transmission period may include determining whether or not respective target positions of a plurality of path points included in the traveling path to be transmitted coincide with respective target positions of a traveling path that has been transmitted to the vehicle before the traveling path to be transmitted is transmitted, and changing the transmission period to a period longer than a basic period in a case where the respective target positions of the traveling path to be transmitted is determined to coincide with the respective target positions of the traveling path that has been transmitted and maintaining the transmission period at the basis period in a case where the respective target positions of the traveling path to be transmitted is determined not to coincide with the respective target positions of the traveling path that has been transmitted.

In the system according to the second aspect of the present disclosure, the management device may be configured to determine that the respective target positions of the latest traveling path coincide with the respective target positions of the past traveling path in a case where a coinciding level of the respective target positions of the latest traveling path with the respective target positions of the past traveling path is equal to or higher than a specified level.

In the system according to the second aspect of the present disclosure, the management device may be configured to perform processing of determining transmission of a traveling path to be transmitted to the vehicle, and the processing of determining transmission of the traveling path to be transmitted may include determining whether or not a distance from a stop position of the vehicle to the target position included in a path end point of the traveling path to be transmitted is equal to or less than a specified distance, and prohibiting the transmission of the traveling path to be transmitted in a case where the distance is determined to be equal to or less than the specified distance and allowing the transmission of the traveling path to be transmitted in a case where the distance is determined not to be equal to or less than the specified distance.

In the system according to the second aspect of the present disclosure, the management device may be configured to perform processing of setting a transmission period of a traveling path to be transmitted to the vehicle, and the processing of setting the transmission period may include determining whether or not a distance from a stop position of the vehicle to the target position included in a path end point of the traveling path to be transmitted is equal to or less than a specified distance, and changing the transmission period to a period longer than a basic period in a case where the distance is determined to be equal to or less than the specified distance and maintaining the transmission period at the basic period in a case where the distance is determined not to be equal to or less than the specified distance.

According to the first or the second aspect, in a case where a traveling state of the vehicle corresponds to a state acquired immediately after the vehicle stops, when a latest interval path is received from the management device, processing of determining restart of the vehicle based on the latest interval path is performed. It is therefore possible to avoid occurrence of a failure due to a speed plan based on the latest interval path received immediately after the vehicle stops being set.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a view illustrating a configuration example of an automated valet parking system;

FIG. 2 is a view illustrating a configuration example of a vehicle system;

FIG. 3 is a view for explaining an example of a traveling path;

FIG. 4 is a view related to a state acquired immediately after stop;

FIG. 5 is a view related to a state acquired immediately after stop;

FIG. 6 is a flowchart indicating a processing example particularly related to an embodiment; and

FIG. 7 is a flowchart indicating a processing example particularly related to the embodiment.

### DETAILED DESCRIPTION OF EMBODIMENTS

An embodiment of the present disclosure will be described below with reference to the drawings. Note that in the respective drawings, the same or corresponding portions are denoted by the same reference numerals, and description thereof will be simplified or omitted.

### 1. Overall Configuration Example of System

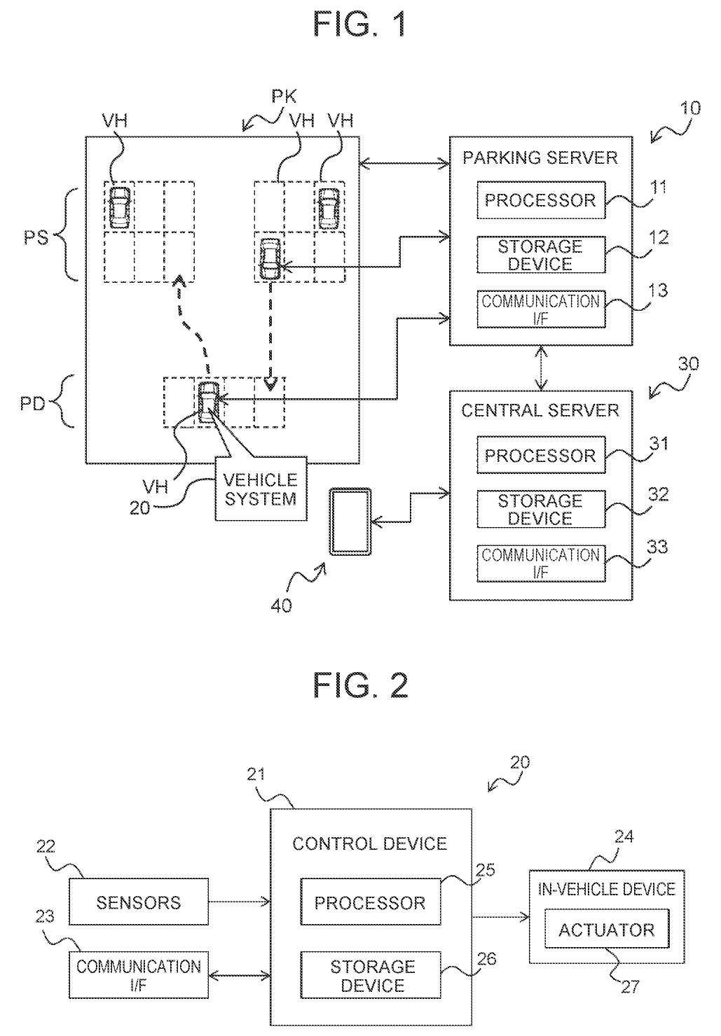

An AVP system is a system that automatically performs parking operation of a vehicle within a predetermined area such as a parking area, a factory and a facility. FIG. 1 is a view illustrating a configuration example of the AVP system. FIG. 1 illustrates a parking area PK as the predetermined area. The parking area PK has a configuration in which AVP can be executed. The configuration in which AVP can be executed includes a pick-up and drop-off space PD and a parking space PS. The pick-up and drop-off space PD is a space for getting off from a vehicle VH and/or getting on to the vehicle VH. The parking space PS is a space for parking the vehicle VH. The configuration in which AVP can be executed also includes a marker that assists movement of the vehicle VH within the parking area PK, sensors (for example, a camera, a radar) that monitor the vehicle VH, and the like. The vehicle VH may be an autonomous vehicle.

FIG. 1 illustrates a management server (hereinafter, also referred to as a "parking server") 10 that manages the AVP in the parking area PK. The parking server 10 is a component corresponding to a "management device" of the present disclosure. The parking server 10 performs various kinds of processing regarding management of reservation of the AVP in the parking area PK. The parking server 10 also performs various kinds of processing regarding management of authority of operation of the vehicle VH necessary for AVP in the parking area PK. The parking server 10 further acquires various kinds of information from the sensors in the parking area PK and performs various kinds of processing regarding execution of the AVP in the parking area PK based on the various kinds of information. The parking server 10 may be a combination of a server (local server) that performs various kinds of processing regarding execution of the AVP and a server (cloud server) that performs various kinds of processing regarding management of the AVP.

The parking server 10 is typically a computer including at least one processor 11, at least one storage device 12, and a communication interface (I/F) 13. The processor 11 executes various kinds of processing. Examples of the processor 11 can include a central processing unit (CPU), a graphics processing unit (GPU), an application specific integrated circuit (ASIC), and a field-programmable gate array (FPGA). The processor 11 can be also referred to as a "circuitry" or a "processing circuitry". The "circuitry" is hardware programmed to implement described functions or hardware that executes functions. The processor 11 reads various kinds of information from the storage device 12 and stores various kinds of information in the storage device 12.

Examples of the storage device 12 can include a volatile memory, a non-volatile memory, a hard disk drive (HDD), and a solid state drive (SSD). Examples of various kinds of information stored in the storage device 12 include parking area map information, parking area usage information, and vehicle management information. The parking area map information indicates map information of the parking area PK. The parking area usage information is information regarding a usage situation (availability information) of the pick-up and drop-off space PD and the parking space PS within the parking area PK. The vehicle management information includes information on a vehicle ID, loading and unloading time, a vehicle position, and the like. The vehicle management information is managed for each vehicle VH. The vehicle ID is identification information of the vehicle VH. The loading and unloading time is information regarding time (such as, for example, reserved time and actual time) of loading and unloading of the vehicle VH. The vehicle position indicates information regarding a position of the vehicle VH within the parking area PK.

The communication I/F 13 is an interface for communicating with a device outside the parking server 10 to transmit/receive information. For example, the communication I/F 13 includes equipment for connecting to a peripheral device through wireless LAN, equipment for connecting to a mobile communication network, equipment for connecting to the Internet, and the like. The parking server 10 transmits/receives information to/from the vehicle VH (vehicle system 20) via the communication I/F 13. The parking server 10 further transmits/receives information to/from a central server 30 via the communication I/F 13.

FIG. 2 is a view illustrating a configuration example of the vehicle system 20. In the example illustrated in FIG. 2, the vehicle system 20 is mounted on each vehicle VH as a system capable of executing the AVP. In the example illustrated in FIG. 2, the vehicle system 20 includes a control device 21, sensors 22, a communication I/F 23 and an in-vehicle device 24.

The control device 21 is communicably connected to the sensors 22, the communication I/F 23 and the in-vehicle device 24. The control device 21 is a computer that performs information processing related to control of the vehicle VH based on various kinds of information. The control device 21 includes at least one processor 25 and at least one storage device 26. A configuration example of the processor 25 is the same as the configuration example of the processor 11 illustrated in FIG. 1. Further, a configuration example of the storage device 26 is the same as the configuration example of the storage device 12 illustrated in FIG. 1. The processor 25 implements information processing related to control of the vehicle VH in cooperation with the storage device 26.

For example, the control device 21 includes one or a plurality of electronic control units (ECUs). In another example, the control device 21 includes a kit (for example, an AVP kit) for functions to be provided by the parking server 10. The control device 21 generates a control signal of the vehicle VH through information processing and outputs the control signal. In a case where the vehicle VH receives an instruction INS of AVP operation (such as, for example, loading operation and unloading operation) from the parking server 10, the control device 21 generates a control signal CON for the AVP operation. The control signal CON is transmitted to the in-vehicle device 24.

The sensors 22 detect information of a peripheral environment and a traveling state of the vehicle VH. Examples of the sensors 22 can include a camera, a radar, a LiDAR, a wheel speed sensor, an inertial measurement unit (IMU) and a global navigation satellite system (GNSS) sensor.

The communication I/F 23 is an interface for communicating with a device outside the vehicle VH to transmit/receive information. The vehicle VH transmits/receives information to/from the parking server 10 via the communication I/F 23. The vehicle VH can also transmit/receive information to/from a user terminal 40 via the communication I/F 23.

The in-vehicle device 24 includes a lighting device, an in-vehicle illumination device, a horn, a direction indicator, a windshield wiper, a door, a door window, a mirror, a drive device, a braking device, a steering device, a human machine interface (HMI), and the like. Each device of the in-vehicle device 24 includes an actuator 27 that can be controlled by the control device 21. The in-vehicle device 24 acquires a control signal from the control device 21. As a result of the actuator 27 operating in accordance with the control signal, control of the in-vehicle device 24 is implemented by the control device 21. Further, control of the vehicle VH is implemented by control of the in-vehicle device 24. As a result of the actuator 27 operating in accordance with the control signal CON for the AVP operation, vehicle control for the AVP operation is implemented.

Returning to FIG. 1, description of the overall configuration example will be continued. FIG. 1 also illustrates the central server 30. The central server 30 is a server (cloud server) that manages the whole of the AVP service. The central server 30 manages a user (hereinafter, also referred to as an "AVP user") who utilizes the AVP service, a vehicle (that is, the vehicle VH) including the vehicle system 20, and the like. Management of the AVP user includes authentication of the AVP user, management of reservation of the AVP by the AVP user, and the like. Management of the vehicle VH includes management of vehicle information of the vehicle VH, management of authority of operation of the vehicle VH, management of an AVP operation log of the vehicle VH, and the like.

The central server 30 is typically a computer including at least one processor 31, at least one storage device 32, and a communication I/F 33. A configuration example of the processor 31 is the same as the configuration example of the processor 11. Further, a configuration example of the storage device 32 is the same as the configuration example of the storage device 12.

Examples of various kinds of information stored in the storage device 32 can include AVP reservation information, user information, and AVP vehicle information. The AVP reservation information is information regarding reservation of the AVP by the AVP user. The AVP reservation information includes information on a parking area that is desired to be utilized by the AVP user, loading and unloading time, and the like. The user information includes information on a user ID of the AVP user, a vehicle ID of the vehicle to be utilized by the AVP user, and the like. The user information is managed for each AVP user. The AVP vehicle information includes information on the vehicle ID of the vehicle including the vehicle system 20, an IP address of the vehicle system 20, an AVP operation log by the vehicle system 20, and the like.

The communication I/F 33 is an interface for communicating with a device outside the central server 30 to transmit/receive information. For example, the communication I/F 33 includes equipment for connecting to a peripheral device through wireless LAN, equipment for connecting to a mobile communication network, equipment for connecting to the Internet, and the like. The central server 30 transmits/receives information to/from the parking server 10 via the communication I/F 33. The central server 30 also transmits/receives information to/from the user terminal 40 via the communication I/F 33.

The user terminal 40 is a terminal (for example, a smartphone) carried by the AVP user. The AVP user transmits/receives information to/from the vehicle VH (vehicle system 20) through operation of the user terminal 40. The AVP user also transmits/receives information to/from the central server 30 through operation of the user terminal 40. The user terminal 40 is used to register usage and reserve usage of the AVP service by the AVP user. The user terminal 40 is also used during the AVP in the parking area PK as appropriate. Note that information regarding the AVP may be transmitted/received through operation of the in-vehicle device 24 (for example, an HMI) illustrated in FIG. 2 instead of operation of the user terminal 40.

### 2. Traveling Path and Traveling Plan

To execute the AVP (loading), for example, the parking server 10 transmits/receives information to/from the central server 30 to acquire authority of operation of the vehicle VH that is waiting in the pick-up and drop-off space PD. As a result of the authority of operation being transferred to the parking server 10, the parking server 10 (processor 11) can execute the AVP of the vehicle VH. The vehicle system 20 (processor 25) generates the control signal CON in accordance with the instruction INS of the AVP operation (loading operation) received from the parking server 10 and performs vehicle control for the AVP operation (loading operation) by controlling the in-vehicle device 24.

To implement the AVP (unloading), for example, the vehicle system 20 (processor 25) generates the control signal CON in accordance with the instruction INS of the AVP operation (unloading operation) received from the parking server 10 and performs vehicle control for the AVP operation (unloading operation) by controlling the in-vehicle device 24. When the vehicle VH arrives at the pick-up and drop-off space PD, the parking server 10 transmits/receives information to/from the central server 30 to return the authority of operation of the vehicle VH. As a result of the authority of operation being transferred to the central server 30, execution of the AVP of the vehicle VH by the parking server 10 (processor 11) ends.

The instruction INS of the AVP operation includes information on the traveling path PT. The traveling path PT is a set of path points PP within the parking area PK through which the vehicle VH should pass from a current place of the vehicle VH to a destination. The instruction INS is sequentially generated based on the information on the peripheral environment and the traveling state of the vehicle VH acquired from the sensors of the parking area PK. The information acquired from the sensors 22 of the vehicle VH may be used to generate the instruction INS. The generated instruction INS is sequentially transmitted to the vehicle VH from the parking server 10. The instruction INS transmitted at each timing includes information on the traveling path PT in a traveling direction of the vehicle VH.

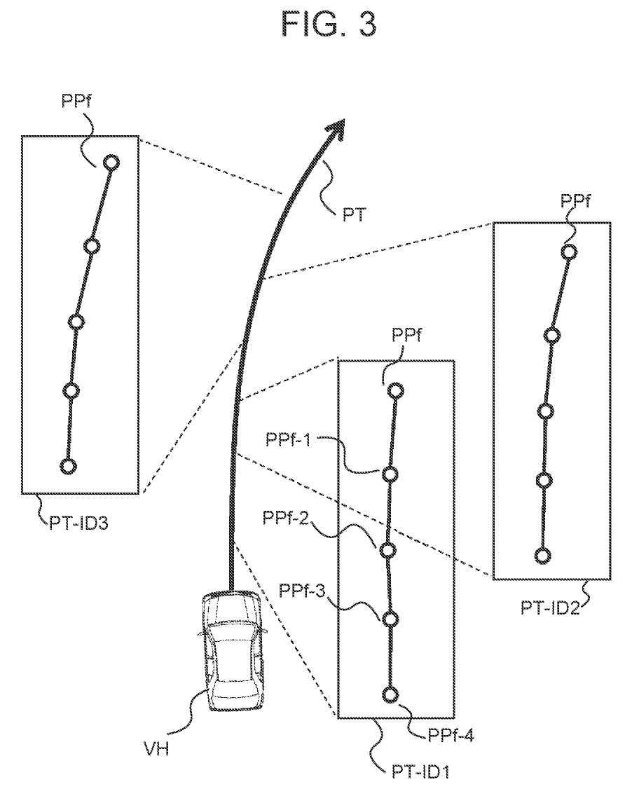

FIG. 3 is a view for explaining an example of the traveling path PT. FIG. 3 illustrates the traveling path PT ahead of the vehicle VH. The traveling path PT includes an interval path PT-ID1, an interval path PT-ID2, and an interval path PT-ID3. The interval paths PT-ID1, PT-ID2 and PT-ID3 are included in the instruction INS sequentially received by the vehicle VH (vehicle system 20) during the AVP operation and are identified by unique IDs provided for each interval path PT-IDk (k ≥ 1).

The interval path PT-IDk includes a path point PP (hereinafter, also referred to as a "path end point PPf") indicating an end point of the interval path PT-IDk. In the example illustrated in FIG. 3, the interval path PT-ID1 includes the path end point PPf, a path point PPf-1, a path point PPf-2, a path point PPf-3 and a path point PPf-4 before the path end point PPf. The path point PPf-4 can be also considered as a path point PP indicating a starting point of the interval path PT-ID1. Configurations of the path points PP of the interval paths PT-ID2 and PT-ID3 are basically the same as the configuration of the path points PP of the interval path point PT-ID1.

Each path point PP included in the interval path PT-IDk includes, for example, position information, rudder angle information, maximum speed information, and curvature information. The position information indicates a target position of the vehicle VH and is expressed by a two-dimensional coordinate (x, y) of the parking area PK. The rudder angle information indicates a target rudder angle of the vehicle VH at the path point PP. The maximum speed information indicates a permissible maximum speed of the vehicle VH at the path point PP. The curvature information indicates a curvature of the interval path PT-IDk.

The vehicle system 20 sets a traveling plan for following the interval path PT-IDk based on the information included in each path point PP of the interval path PT-IDk and information on the peripheral environment and the traveling state of the vehicle VH. The set traveling plan includes a speed plan and a rudder angle plan. The vehicle system 20 also performs vehicle control in accordance with the set traveling plan. Specifically, the vehicle system 20 calculates deviation (for example, speed deviation, lateral position deviation, yaw angle deviation) between the vehicle VH and the traveling plan, generates a control target value (for example, a target acceleration, a target rudder angle) such that the deviation decreases, and transmits the control signal CON to the actuator 27 (for example, a drive actuator, a braking actuator and a steering actuator). By this means, the AVP operation along the traveling path PT is performed.

### 3. State Acquired Immediately After Stop

The traveling plan is set based on the latest interval path of the vehicle system 20. For example, a case will be considered where the interval path PT-IDk is received from the parking server 10 during the AVP operation based on the traveling plan that follows the interval path PT-IDk-1. In this case, the vehicle system 20 sets a traveling plan that follows the interval path PT-IDk that is the latest interval path in consideration of the information on the peripheral environment and the traveling state of the vehicle VH and performs vehicle control for the AVP operation.

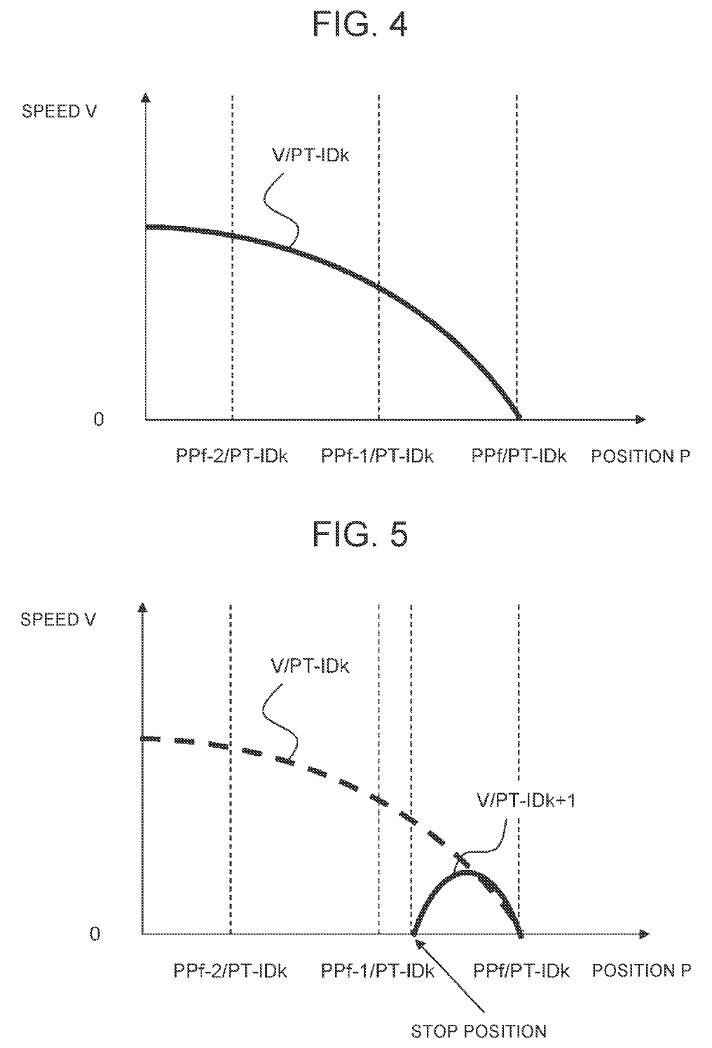

Here, a case where a traveling state of the vehicle VH corresponds to a state acquired immediately after stop will be described. FIG. 4 and FIG. 5 are views related to a state acquired immediately after stop. FIG. 4 indicates an example of a speed plan V/PT-IDk that follows the interval path PT-IDk. The interval path PT-IDk is the latest interval path at current time. The interval path PT-IDk is, for example, an interval path when a target position (x, y) indicated by the path end point PPf corresponds to the final destination of the vehicle VH. In another example, the interval path PT-IDk is an interval path when the target position (x, y) indicated by the path end point PPf corresponds to a temporary stop position because of approach of a moving object to the vehicle VH.

A case will be considered where as a result of vehicle control based on the speed plan V/PT-IDk that follows the interval path PT-IDk, the stop position of the vehicle VH does not coincide with the target position (x, y) of the path end point PPf of the interval path PT-IDk. In this case, a minor adjustment of the stop position is made. Specifically, the vehicle system 20 receives the instruction INS including the interval path PT-IDk+1 from the parking server 10 and sets the speed plan V/PT-IDk+1 that follows the interval path PT-IDk+1 that is the latest interval path. The speed plan V/PT-IDk+1 indicated in FIG. 5 is one example of the speed plan that follows the interval path PT-IDk+1.

However, as can be understood from a reason for making a minor adjustment of the stop position, the target position (x, y) indicated by the path end point PPf of the interval path PT-IDk+1 becomes the same position as the target position (x, y) indicated by the path end point PPf of the interval path PT-IDk. In a case where a minor adjustment of the stop position is made, there is also a possibility that there may be little difference in the target position (x, y) indicated by the path point PP (for example, the path point PPf-1 or PPf-2) before the path end point PPf between the interval path PT-IDk+1 and the interval path PT-IDk.

However, the traveling plan is set based on the latest interval path, and thus, when the vehicle system 20 receives the latest interval path from the parking server 10, the traveling plan is set. If the vehicle system 20 sets the speed plan V/PT-IDk+1 based on the interval path PT-IDk+1 that is the latest interval path, hunting of an internal state of the vehicle VH occurs, or actuator control that is originally unnecessary is performed.

### 4. Restart Determination Processing

### 4-1. Processing by Vehicle System

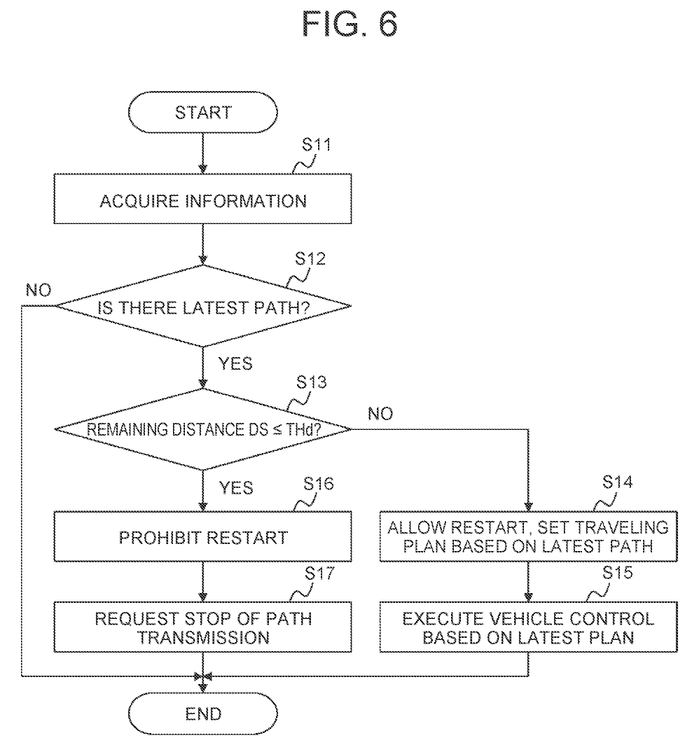

Thus, in the embodiment, in a case where the traveling state of the vehicle VH corresponds to a state acquired immediately after stop, when the vehicle system 20 (control device 21) receives the latest interval path, processing of determining restart of the vehicle VH based on the latest interval path is performed. FIG. 6 is a flowchart indicating a processing example particularly related to the embodiment. Note that processing routine indicated in FIG. 6 is repeatedly executed at a predetermined period by the vehicle system 20 (processor 25) while the vehicle VH stops.

In the processing routine indicated in FIG. 6, first, information is acquired (step S11). Examples of the information to be acquired in the processing in step S11 can include the instruction INS transmitted from the parking server 10, and the information on the peripheral environment and the traveling state of the vehicle VH acquired from the sensors 22. In the processing in step S11, information on a current position (that is, a stop position) of the vehicle VH is also acquired. The current position of the vehicle VH is, for example, acquired through position estimation processing (localization processing) of the vehicle VH performed by the parking server 10 or the vehicle system 20.

Subsequent to the processing in step S11, it is determined whether or not the instruction INS includes the latest interval path (step S12). The processing in step S12 is performed based on a unique ID of the interval path included in the instruction INS. In a case where a negative determination result is obtained in step S12, the processing routine ends.

In a case where a positive determination result is obtained in step S12, it is determined whether or not a remaining distance DS from the current position of the vehicle VH to the target position (x, y) indicated by the path end point PPf included in the latest interval path is equal to or less than a specified distance THd (step S13). The remaining distance DS is calculated based on information on the latest interval path specified in the processing in step S12 and the current position of the vehicle VH acquired in the processing in step S11. Note that the specified distance THd (for example, from 1 to 5 m) to be compared with the remaining distance DS is set in advance.

In another processing example of step S13, it is determined whether or not a coinciding level of information included in the latest interval path with information included in the past interval path (that is, the interval path previously received before reception of the latest interval path) received from the parking server 10 before this latest interval path is received is equal to or higher than a specified level THLv. In other words, the management device is configured to determine that respective target positions of a latest traveling path coincide with respective target positions of the past traveling path in a case where the coinciding level of the respective target positions of the latest traveling path with the respective target positions of the past traveling path is equal to or higher than the specified level THLv.

As described above, each path point PP included in the interval path PT-IDk includes position information, rudder angle information, maximum speed information, and curvature information. In another processing example of step S13, position information is compared between the latest interval path and the past interval path. The comparison of the position information is performed for two path points PP based on the path end point PPf. Specifically, the target position (x, y) indicated by the path end point PPf of the latest interval path is compared with the target position (x, y) indicated by the path end point PPf of the past interval path, and the target position (x, y) indicated by the path point PPf-i (i ≥ 1) of the latest interval path is compared with the target position (x, y) indicated by the path end point PPf of the past interval path.

In another processing example of step S13, the rudder angle information may be compared between the latest interval path and the past interval path in addition to the comparison of the position information between the latest interval path and the past interval path. The comparison of the rudder angle information can be performed, for example, in a case where a coinciding level of the position information between the latest interval path and the past interval path is the specified level THLv. Concept of the comparison of the rudder angle information is the same as concept of the comparison of the position information.

In another processing example of step S13, in a case where the coinciding level of the information included in the latest interval path with the information included in the past interval path is equal to or higher than the specified level THLv, it is determined that the information included in the latest interval path coincides with the information included in the past interval path. In a case where it is determined that the level is not equal to or higher than the specified level THLv, it is determined that the information included in the latest interval path does not coincide with the information included in the past interval path.

In a case where a negative determination result is obtained in step S13, restart of the vehicle VH is allowed. In this case, the traveling plan is set based on the latest interval path (step S14). The processing in step S14 is performed based on, for example, the latest interval path (for example, the interval path PT-IDk+1) acquired in step S11, the current position of the vehicle VH, and a traveling speed (= 0) of the vehicle VH. Then, vehicle control based on the set latest traveling plan (speed plan V/PT-IDk+1) is executed (step S15).

In a case where a positive determination result is obtained in step S13, restart of the vehicle VH is prohibited (step S16). Further, a request for stopping transmission of a new traveling path is transmitted to the parking server 10 (step S17). As a result of the processing of step S17 being performed, a new traveling path is not transmitted from the parking server 10 to the vehicle system 20, and thus, the traveling plan is not set by the vehicle system 20.

### 4-2. Processing by Parking Server

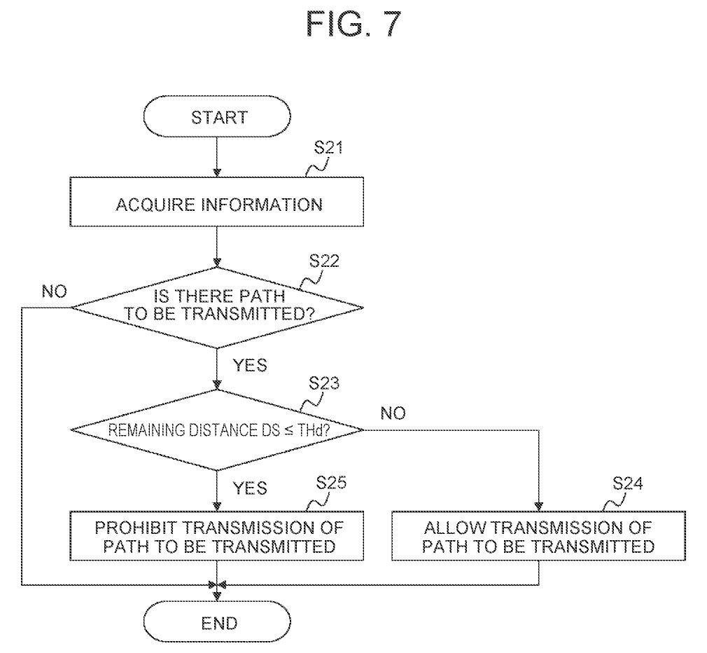

The processing of determining restart of the vehicle VH described in FIG. 6 is performed with intention to avoid a traveling plan from being set based on a new interval path for the purpose of making a minor adjustment of the stop position. The processing performed with the same intention as the intention of this processing can be also performed at the parking server 10. FIG. 7 is a flowchart indicating a processing example particularly related to the embodiment. Note that processing routine indicated in FIG. 7 is repeatedly executed at a predetermined period by the parking server 10 (processor 11) while the vehicle VH stops.

In the processing routine indicated in FIG. 7, first, information is acquired (step S21). Examples of the information to be acquired in the processing in step S21 can include information on the peripheral environment and the traveling state of the vehicle VH acquired from the sensors of the parking area PK or the sensors 22 of the vehicle VH. In the processing in step S21, a current position (that is, a stop position) of the vehicle VH is also acquired. The current position of the vehicle VH is, for example, acquired through position estimation processing (localization processing) of the vehicle VH.

Subsequent to the processing in step S21, it is determined whether or not an interval path to be transmitted to the vehicle VH is included (step S22). In a case where a negative determination result is obtained in step S22, the processing routine ends.

In a case where a positive determination result is obtained in step S22, it is determined whether or not the remaining distance DS from the current position of the vehicle VH to the target position (x, y) indicated by the path end point PPf included in the interval path to be transmitted to the vehicle VH is equal to or less than a specified distance THd (step S23). The specified distance THd used in the processing in step S23 is the same threshold as the specified distance THd used in the processing in step S13 in FIG. 6.

The other processing example of the step S13 described in FIG. 6 can be also applied to step S23. In other words, in another processing example of step S23, it is determined whether or not a coinciding level of the information included in the interval path to be transmitted to the vehicle VH with the information included in the past interval path that has been transmitted to the vehicle VH before this interval path to be transmitted is transmitted (that is, the interval path that is previously generated before generation of the interval path to be transmitted to the vehicle VH and transmitted to the vehicle VH) is equal to or higher than the specified level THLv.

In the other processing example of step S23, in a case where the coinciding level of the information included in the interval path to be transmitted to the vehicle VH with the information included in the past interval path is equal to or higher than the specified level THLv, it is determined that the information included in the interval path to be transmitted coincides with the information included in the past interval path. In a case where the level is not equal to or higher than the specified level THLv, it is determined that the information included in the interval path to be transmitted does not coincide with the information included in the transmitted interval path.

In a case where a negative determination result is obtained in step S23, transmission of the interval path to be transmitted is allowed (step S24). In a case where a positive determination result is obtained in step S23, transmission of the interval path to be transmitted is prohibited (step S25). Note that processing in step S24 or S25 can be performed based on the determination result of the above-described other processing example in step S23

In another processing example of step S24 and S25, a transmission period of the interval path from the parking server 10 to the vehicle VH is set. The transmission period of the interval path is set at a basic period (for example, approximately from 100 to 500 ms). In the other processing example of step S24, this transmission period is maintained at the basic period. On the other hand, in the other processing example of step S25, this transmission period is changed to a period (for example, from 500 to 800 ms) longer than the basic period. As a result of the transmission period being made longer in this manner, it is possible to reduce a frequency of occurrence of a failure due to the speed plan based on the new interval path for the purpose of minor adjustment of the stop position being set.

### 5. Effects

According to the embodiment described above, in a case where the traveling state of the vehicle VH corresponds to a state acquired immediately after stop, when the vehicle system 20 receives the latest interval path, restart determination processing is performed in the vehicle system 20. Alternatively, processing that is performed with the same intention as the intention of this processing is performed in the parking server 10. It is therefore possible to avoid occurrence of a failure due to the speed plan based on the new interval path for the purpose of minor adjustment of the stop position being set.

What is claimed is:

1. A system that is configured to perform automated valet parking of a vehicle within a predetermined area, the system comprising:
a management device configured to manage the automated valet parking; and
a control device mounted on the vehicle and configured to perform vehicle control for the automated valet parking based on a traveling path intermittently received from the management device, wherein:
the traveling path includes a plurality of path points;
each of the plurality of path points includes information on a target position of the vehicle;
the vehicle control includes processing of determining restart of the vehicle based on the latest traveling path when the control device receives a latest traveling path from the management device in a case where a traveling state of the vehicle corresponds to a state acquired immediately after the vehicle stops; and
the processing of determining the restart includes determining whether or not a distance from a stop position of the vehicle to the target position included in a path end point of the latest traveling path is equal to or less than a specified distance, and prohibiting the restart in a case where the distance is determined to be equal to or less than the specified distance and allowing the restart in a case where the distance is determined not to be equal to or less than the specified distance.

2. A system that is configured to perform automated valet parking of a vehicle within a predetermined area, the system comprising:
a management device configured to manage the automated valet parking; and
a control device mounted on the vehicle and configured to perform vehicle control for the automated valet parking based on a traveling path intermittently received from the management device, wherein:
the traveling path includes a plurality of path points;
each of the plurality of path points includes information on a target position of the vehicle;
the vehicle control includes processing of determining restart of the vehicle based on the latest traveling path when the control device receives a latest traveling path from the management device in a case where a traveling state of the vehicle corresponds to a state acquired immediately after the vehicle stops; and
the processing of determining the restart includes determining whether or not respective target positions of a plurality of path points included in the latest traveling path coincide with respective target positions of a plurality of path points included in a past traveling path received from the management device before the latest traveling path is received. and
prohibiting the restart in a case where the respective target positions of the latest traveling path are determined to coincide with the respective target positions of the past traveling path and allowing the restart in a case where the respective target positions of the latest traveling path are determined not to coincide with the respective target positions of the past traveling path.

3. The system according to claim 1, wherein in a case where the control device prohibits the restart, the control device is configured to further perform processing of transmitting a transmission stop request of the traveling path to the management device.

4. The system according to claim 1, wherein:
the management device is configured to perform processing of determining transmission of a traveling path to be transmitted to the vehicle; and
the processing of determining transmission of the traveling path to be transmitted includes
determining whether or not a distance from the stop position of the vehicle to the target position included in a path end point of the traveling path to be transmitted is equal to or less than the specified distance, and
prohibiting the transmission of the traveling path to be transmitted in a case where the distance is determined to be equal to or less than the specified distance and allowing the transmission of the traveling path to be transmitted in a case where the distance is determined not to be equal to or less than the specified distance.

5. The system according to claim 1, wherein:
the management device is configured to perform processing of determining transmission of a traveling path to be transmitted to the vehicle; and
the processing of determining transmission of the traveling path to be transmitted includes determining whether or not respective target positions of a plurality of path points included in the traveling path to be transmitted coincide with respective target positions of a traveling path that has been transmitted to the vehicle before the traveling path to be transmitted is transmitted, and prohibiting the transmission of the traveling path to be transmitted in a case where the respective target positions of the traveling path to be transmitted are determined to coincide with the respective target positions of the traveling path that has been transmitted and allowing the transmission of the traveling path to be transmitted in a case where the respective target positions of the traveling path to be transmitted are determined not to coincide with the respective target positions of the traveling path that has been transmitted.

6. The system according to claim 1, wherein:
the management device is configured to perform processing of setting a transmission period of a traveling path to be transmitted to the vehicle; and
the processing of setting the transmission period includes determining whether or not a distance from the stop position of the vehicle to the target position included in a path end point of the traveling path to be transmitted is equal to or less than the specified distance, and changing the transmission period to a period longer than a basic period in a case where the distance is determined to be equal to or less than the specified distance and maintaining the transmission period at the basic period in a case where the distance is determined not to be equal to or less than the specified distance.

7. The system according to claim 1, wherein:
the management device is configured to perform processing of setting a transmission period of a traveling path to be transmitted to the vehicle; and
the processing of setting the transmission period includes determining whether or not respective target positions of a plurality of path points included in the traveling path to be transmitted coincide with respective target positions of a traveling path that has been transmitted to the vehicle before the traveling path to be transmitted is transmitted, and changing the transmission period to a period longer than a basic period in a case where the respective target positions of the traveling path to be transmitted is determined to coincide with the respective target positions of the traveling path that has been transmitted and maintaining the transmission period at the basic period in a case where the respective target positions of the traveling path to be transmitted is determined not to coincide with the respective target positions of the traveling path that has been transmitted.

8. The system according to claim 2, wherein the management device is configured to determine that the respective target positions of the latest traveling path coincide with the respective target positions of the past traveling path in a case where a coinciding level of the respective target positions of the latest traveling path with the respective target positions of the past traveling path is equal to or higher than a specified level.

9. The system according to claim 2, wherein:
the management device is configured to perform processing of determining transmission of a traveling path to be transmitted to the vehicle; and
the processing of determining transmission of the traveling path to be transmitted includes determining whether or not a distance from a stop position of the vehicle to the target position included in a path end point of the traveling path to be transmitted is equal to or less than a specified distance, and prohibiting the transmission of the traveling path to be transmitted in a case where the distance is determined to be equal to or less than the specified distance and allowing the transmission of the traveling path to be transmitted in a case where the distance is determined not to be equal to or less than the specified distance.

10. The system according to claim 2, wherein:
the management device is configured to perform processing of setting a transmission period of a traveling path to be transmitted to the vehicle; and
the processing of setting the transmission period includes determining whether or not a distance from a stop position of the vehicle to the target position included in a path end point of the traveling path to be transmitted is equal to or less than a specified distance, and changing the transmission period to a period longer than a basic period in a case where the distance is determined to be equal to or less than the specified distance and maintaining the transmission period at the basic period in a case where the distance is determined not to be equal to or less than the specified distance.
